(19) United States
(12) Patent Application Publication
(10) Pub. No.: US 2025/0202173 A1
(43) Pub. Date: Jun. 19, 2025

(54) Electrical Connector and Connector Assembly

(71) Applicant: Tyco Electronics (Shanghai) Co., Ltd., Shanghai (CN)

(72) Inventors: Jiaoyong (Mac) Liu, Shanghai (CN); Jie (Roger) Luo, Foshan (CN); Wenxia Zhou, Shanghai (CN); Wei Yao, Kunshan (CN)

(73) Assignee: Tyco Electronics (Shanghai) Co., Ltd., Shanghai (CN)

(21) Appl. No.: 18/978,087

(22) Filed: Dec. 12, 2024

(30) Foreign Application Priority Data
Dec. 15, 2023 (CN) 202311734264.5

(51) Int. Cl. H01R 24/60; H01R 13/502; H01R 13/516; H01R 13/627; H01R 13/66

(52) U.S. Cl. CPC H01R 24/60; H01R 13/502; H01R 13/516; H01R 13/6273; H01R 13/6683

(57) ABSTRACT

An electrical connector includes a housing, an insulation module at least partially disposed within the housing, a plurality of connection terminals installed in the insulation module at intervals, and an interconnection member installed on the insulation module. The plurality of connection terminals have different electrical functions. The interconnection member electrically interconnects at least two connection terminals of the plurality of connection terminals.

### CROSS-REFERENCE TO RELATED APPLICATIONS

This application claims the benefit of the filing date under 35 U.S.C. § 119 (a)-(d) of Chinese Patent Application No. 202311734264.5, filed on Dec. 15, 2023.

### FIELD OF THE INVENTION

The present invention relates to a connector, and more particularly, to an electrical connector and a connector assembly.

### BACKGROUND OF THE INVENTION

An electrical connector, such as a cable connector, is generally used to establish an electrical connection between a variety of electronic elements or devices, and its application covers electronic elements or devices such as a household appliance, industrial equipment, a power rack in a data center, a server, etc. The electrical connector generally includes a connection terminal, such as a signal terminal, a power terminal, a ground terminal, etc., provided in a housing to achieve this electrical connection.

In some applications, an electrical interconnection may need to be established between some connection terminals to achieve a specific circuit. However, in conventional technology, the various terminals installed in the same connector housing are separated from each other, and there is no electrical connection between them or it is difficult to establish an electrical interconnection between them, impairing some application scenarios that require stable electrical connection in the connector housing.

Presently, different cables corresponding to the terminals that require electrical interconnection therebetween are generally welded together. For example, wire cores of the stripped cables are welded together at a position before the cables enter holes of the connector. This method of welding the interconnection may still be feasible for stacking cables with small diameters, but when stacking cables with large diameters, it will greatly affect a size, such as a height, of the product, may make correct assembly of the connector impossible, and may require a large installation space to install the connector. In addition, this method will reduce the flexibility of the cable at the welding position.

### SUMMARY OF THE INVENTION

An electrical connector includes a housing, an insulation module at least partially disposed within the housing, a plurality of connection terminals installed in the insulation module at intervals, and an interconnection member installed on the insulation module. The plurality of connection terminals have different electrical functions. The interconnection member electrically interconnects at least two connection terminals of the plurality of connection terminals.

### BRIEF DESCRIPTION OF DRAWINGS

The invention will now be described by way of example with reference to the accompanying figures, of which:

FIG. 1 is a top perspective view of a connector assembly having an electrical connector and a mating connector according to an embodiment;

FIG. 2 is a top perspective view of the connector assembly of FIG. 1 having the electrical connector of FIG. 1 and a mating connector according to another embodiment;

FIG. 3 is a side perspective view of the electrical connector of FIG. 1;

FIG. 4 is a rear perspective view of the electrical connector of FIG. 1;

FIG. 5 is a top view of the electrical connector of FIG. 1;

FIG. 6 is a sectional side view of the electrical connector of FIG. 1, taken along line A-A′ shown in FIG. 5;

FIG. 7 is a perspective sectional view of the electrical connector of FIG. 1 where portions of a housing and an insulation module of the electrical connector are cut away to expose the connection terminals and an interconnection member;

FIG. 8 is another perspective sectional view of the electrical connector of FIG. 1 where portions of the housing and the insulation module of the electrical connector are cut away to expose the connection terminals and the interconnection member;

FIG. 9 is an exploded perspective view of the electrical connector of FIG. 1 where the housing of the electrical connector is removed to expose the interconnection member installed in the insulation module;

FIG. 10 is a perspective view of an assembled state of the connection terminals and the interconnection member of the electrical connector of FIG. 1;

FIG. 11 is an exploded perspective view of the connection terminal of the electrical connector of FIG. 1;

FIG. 12 is a perspective view of the interconnection member of the electrical connector of FIG. 1; and

FIG. 13 is a perspective view of an interconnection member according to another embodiment.

### DETAILED DESCRIPTION

Embodiments of the present disclosure will be described hereinafter in detail taken in conjunction with the accompanying figures. In the description, the same or similar parts are indicated by the same or similar reference numerals. The description of each of the embodiments of the present disclosure hereinafter with reference to the accompanying figures is intended to explain the general inventive concept of the present disclosure and should not be construed as a limitation on the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the figure(s).

In the following detailed description, directional terms, such as “front”, “back”, “up”, “down”, “top”, “bottom”, “left”, “right”, “upper” and “lower”, “inner”, “outer”, etc., may be defined by the figures, but the shape and the location of the component is not limited by the term and can be adjusted according to the application in which the component is used.

In addition, the terms used herein are for the purpose of describing exemplary embodiments only and are not intended to limit and/or restrict the present disclosure. Words in singular form such as “a”, “an” and “the” are intended to include the plural forms as well, unless the context clearly indicates otherwise. In the present disclosure, the terms “including”, “having”, and the like, are used to specify features, numbers, operations, elements, components, or combinations thereof, but do not preclude the presence or addition of one or more of the features, elements, operations, elements, components, or combinations thereof.

Although the terms “first”, “second”, etc., may be used herein to describe various elements, the elements are not limited by these terms. These terms are only used to distinguish one element from another element. For example, without departing from the scope of the disclosure, a first element may be termed as a second element, and a second element may be termed as a first element. The term “and/or” includes a plurality of combinations of relevant items or any one item among a plurality of relevant items.

The embodiments described below are merely exemplary, and as such it would be appreciated by those skilled in the art that various changes or modifications may be made to these embodiments without departing from the principles and spirit of the disclosure, the scope of which is defined by the appended claims and their equivalents. It should be noted that, the terms such as “comprise”, “include”, “have” or the like as used herein don't exclude other elements or steps.

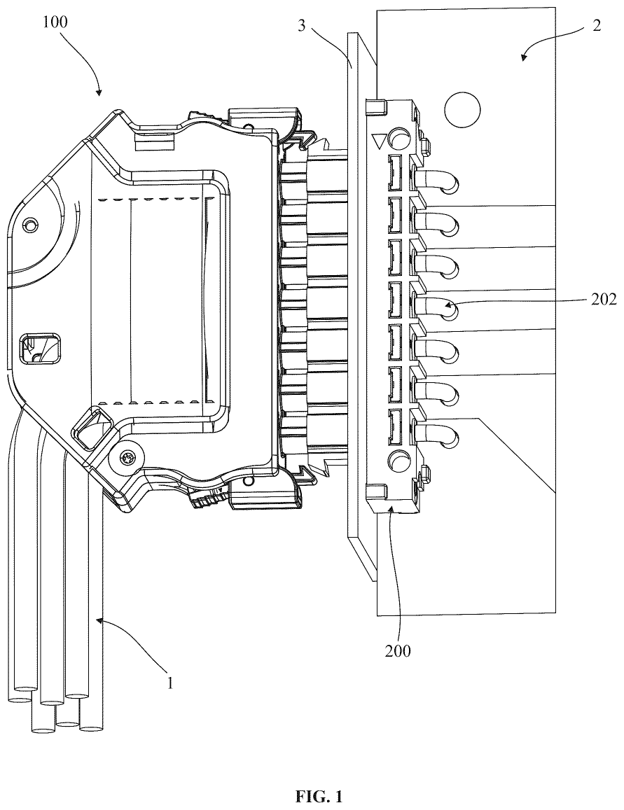

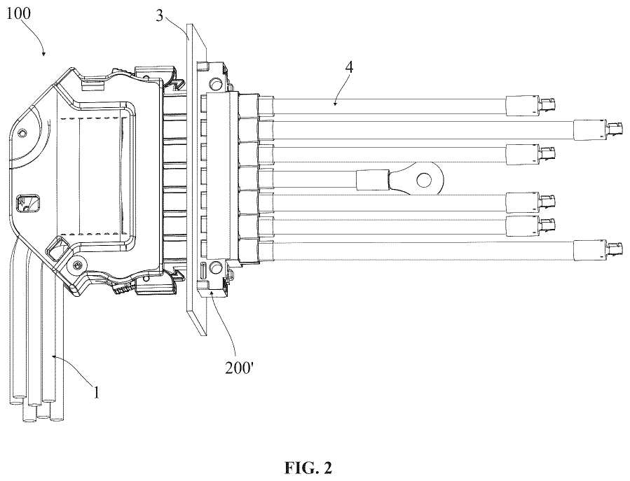

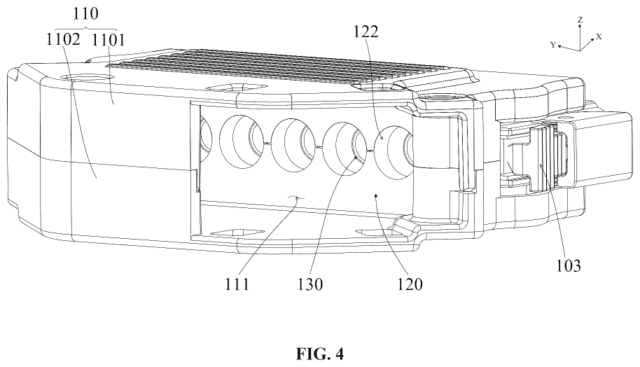

A connector assembly according to an embodiment is shown in FIGS. 1-2. The connector assembly comprises an electrical connector 100 and a mating connector 200, the electrical connector 100 and the mating connector 200 are adapted to be mated with each other. The electrical connector 100 may be a multi-pin/socket connector adapted to connect a plurality of cables 1, such as a five-pin input connector for a Open Compute Project (OCP) ORv2 power rack or a seven-pin AC input connector for a (OCP) ORv3 power rack; however, the present disclosure is not limited to just the aforementioned examples. The mating connector 200 may be a board end connector as shown in FIG. 1, which is adapted to be installed (such as soldered) on a circuit board 2 via a terminal(s) 202 and may be fixed to a cabinet or power rack 3. In another embodiment, the mating connector 200 may also be a wire end connector 200′ as shown in FIG. 2, which is adapted to connect a plurality of cables 4. In the illustrated embodiments, the electrical connector 100 has a substantially flat profile as a whole and has a mating end configured to be mated with the mating connector 200 and an opposite cable connecting end, as shown in FIG. 4.

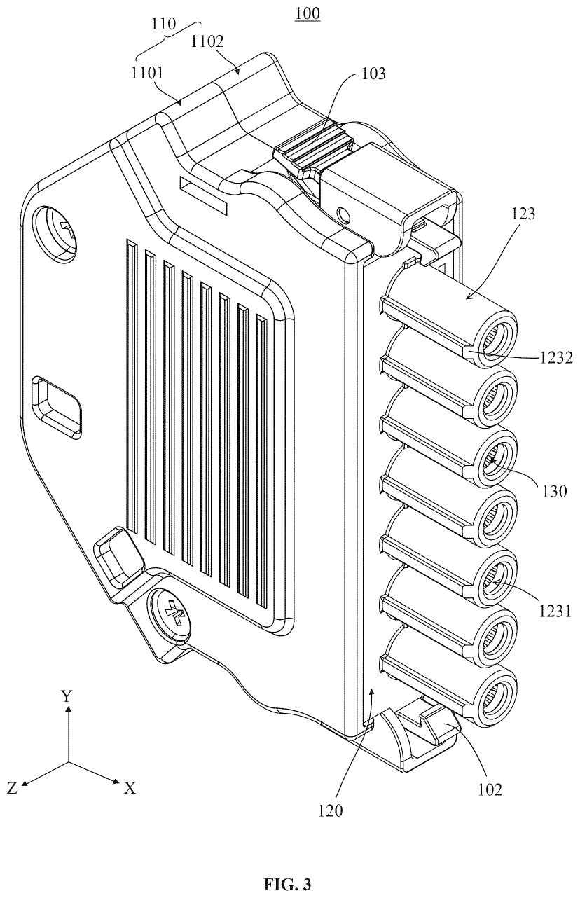

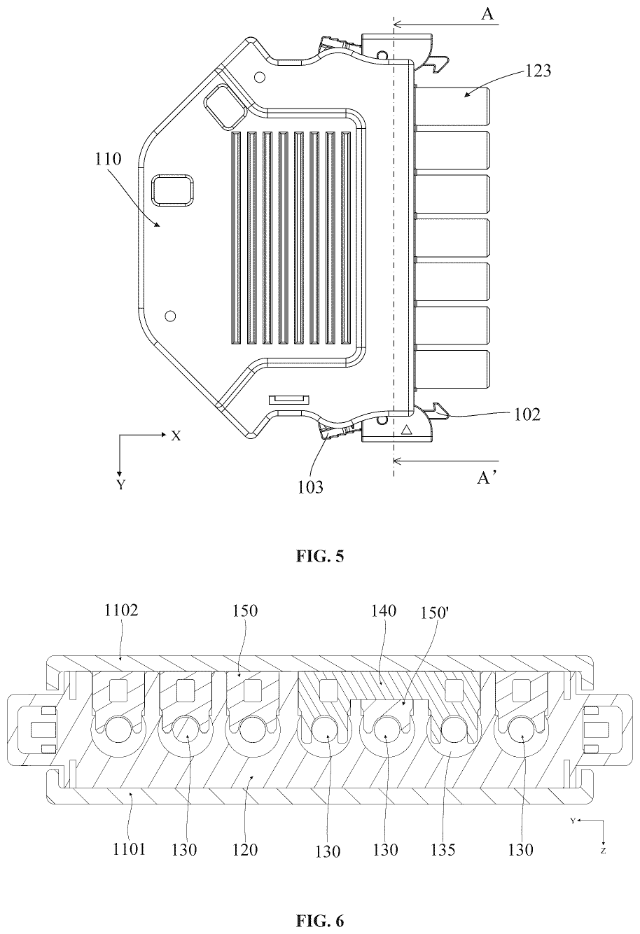

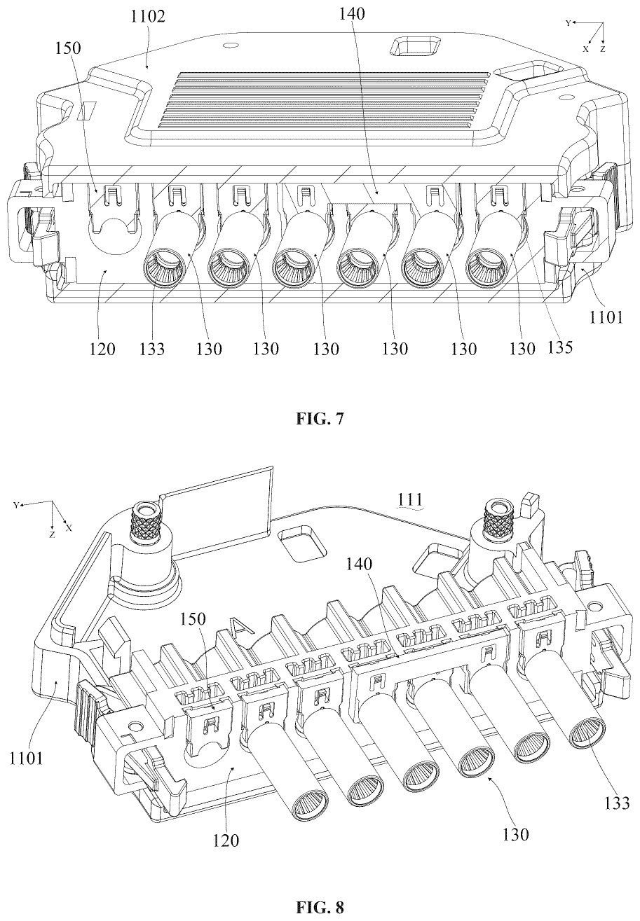

In the exemplary embodiments, as shown in FIGS. 1-9, the electrical connector 100 comprises a housing 110, an insulation module 120 at least partially disposed or fixed within the housing 110, and a plurality of connection terminals 130 at least partially installed in the insulation module 120. The housing 110 defines an appearance of the electrical connector 100. In the present embodiment, the housing 110 comprises two shells 1101, 1102 that may be detachably assembled and fixed together to facilitate the assembling and disassembling of the insulation module 120 and the plurality of connection terminals 130, as shown in FIGS. 3-8. In another embodiment, the housing 110 may be a single shell. The housing 110 may be formed with a cable introducing port 111, as shown in FIG. 4, at the cable connecting end, through which the cable 1 may be introduced into the electrical connector 100 and make electrical contact with the plurality of connection terminals 130 installed in the insulation module 120. The insulation module 120, which may also be referred to as a terminal installation module or a base, is made (for example, by molding) of an insulation material, such as a plastic.

As shown in FIGS. 3-5, the housing 110 or the insulation module 120 may be provided with a locking member, which may include a latch 102 and a releasing portion 103 positioned opposite to each other. The latch 102 is engaged with a corresponding structure of the mating connector 200 to lock the electrical connector 100 and the mating connector 200 together. The latch 102 may be deflected to release or unlock the engagement by pressing the releasing portion 103, so as to disengage the electrical connector 100 from the mating connector 200.

The plurality of connection terminals 130, which may also be called electrical contacts, are physically separated from each other in the insulation module 120. Additionally, for example, the plurality of connection terminals 130 are spaced apart in a Y direction, as shown in FIGS. 3-4 and 6-9. It should be noted that in the present text, “a” or “the” “plurality of connection terminals 130” of the electrical connector 100 are terminals with different electrical functions (e.g., electrical connections/signal connections for achieving different electrical functions). For example, for a seven-pin/socket AC input connector, there will be three input terminals, three return terminals, and one ground terminal. In conventional technology, these connection terminals in an electrical connector are generally not interconnected or are electrically isolated from other; in some applications, however, users require the interconnection or short-circuiting of several pins or sockets of the connector to achieve a specific circuit. For this purpose, the conventional technology generally connects (e.g., welds) the cables corresponding to the pins or the sockets, which need to be interconnected, at positions outside of the connector, but this may lead to problems such as a large connector size and an unstable cable connection.

In embodiments of the present application, an interconnection member 140, shown in FIGS. 6-10, is provided in the housing 110 of the electrical connector 100. The interconnection member 140 may be made of a conductive material such as copper or copper alloy and configured to have a shape adapted to electrically interconnect at least two connection terminals of the plurality of connection terminals 130. The interconnection member 140 may be installed onto the insulation module 120 without increasing a size (such as a height or a thickness) of the electrical connector 100, thereby reducing an installation space of the electrical connector 100. The interconnection member 140 removes the need for additional processes such as wire stripping and welding of a cable core. For example, the interconnection member 140 may electrically interconnect the plurality of connection terminals 130 positioned adjacent to each other, or one or more other connection terminals of the plurality of connection terminals 130 may be positioned between the plurality of connection terminals 130 that are electrically interconnected by the interconnection member 140, which can be designed and selected based on the requirements of the terminal interconnection.

For example, as shown in FIGS. 6-10 and 12-13, the fourth and sixth terminals, starting from a left side of the figures, of the illustrated seven connection terminals are electrically connected by the interconnection member 140, or the fourth, the sixth, and the seventh terminals, starting from a left side of the figures, of the illustrated seven connection terminals may be electrically connected by the interconnection member 140. However, the present disclosure is not specifically limited to those embodiments and may apply to various other connections different than those described above. In some applications, the interconnection of the plurality of connection terminals 130 may increase a conductive cross-sectional area, thereby improving the current carrying capacity of the plurality of connection terminals 130. In other applications, this type of interconnection may be used to monitor electrical or thermal performances of the electrical connector 100, as described below.

As shown in FIGS. 3-4 and 6-9, the insulation module 120 comprises a module body 121. As shown in FIG. 4, a plurality of installation holes 122 are formed in the module body 121. The plurality of installation holes 122 penetrate the module body 121, for example, in a first direction (such as a X direction in the figures), and each connection terminal of the plurality of connection terminals 130 is installed in one installation hole of the plurality of installation holes 122. In some embodiments, the insulation module 120 may further comprise a plurality of sleeves 123, each sleeve of the plurality of sleeves 123 extends from the module body 121. In various other embodiments, the insulation module 120 does not have the plurality of sleeves 123.

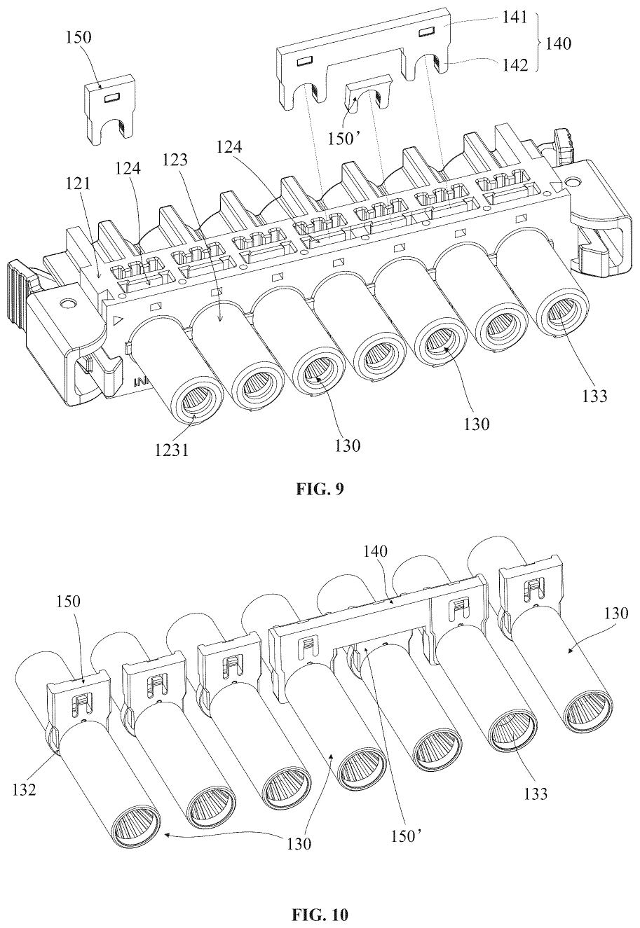

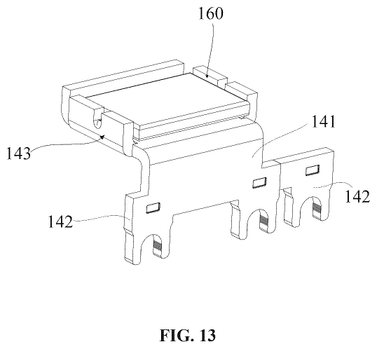

Each sleeve of the plurality of sleeves 123 has a socket 1231, as shown in FIGS. 9 and 13, aligned with a corresponding installation hole 122 of the plurality of installation holes 122 in the first direction such that at least a portion of each connection terminal of the plurality of connection terminals 130 is positioned in the socket 1231 of the corresponding sleeve of the plurality of sleeves 123. Each sleeve of the plurality of sleeves 123 may protect each connection terminal of the plurality of connection terminals 130 from being directly exposed and damaged. After being assembled, each sleeve of the plurality of sleeves 123 may be exposed from the housing 110 to be mated with the mating connector 200, so that a terminal of the mating connector 200 is inserted into a respective socket 1231 to make electrical contact with the corresponding connection terminal of the plurality of connection terminals 130. Additionally, for example, a guiding rib 1232, as shown in FIG. 3, extends in the first direction and may be formed on an outer surface of each sleeve of the plurality of sleeves 123 and configured for guiding the mating connection between the electrical connector 100 and the mating connector 200.

In the illustrated embodiment, the module body 121 is further formed with a plurality of insertion slots 124, as shown in FIG. 9. Each insertion slot of the plurality of insertion slots 124 being in communication with one corresponding installation hole of the plurality of installation holes 122. The interconnection member 140 is adapted to be partially inserted into at least two corresponding insertion slots of the plurality of insertion slots 124 to make electrical contact with at least two connection terminals of the plurality of connection terminals 130 installed in the installation holes of the plurality of installation holes 122 corresponding to or communicated with the at least two insertion slots of the plurality of insertion slots 124, thereby removing the need for welding corresponding cable cores at a position outside of the electrical connector 100. The number of the plurality of insertion slots 124 may be the same as that of the plurality of installation holes 122 or the plurality of connection terminals 130, so as to selectively insert the interconnection member 140 into the corresponding insertion slots of the plurality of insertion slots 124 as required to meet different requirements of interconnection applications.

In another embodiment, the plurality of insertion slots 124 may also be provided only at positions corresponding to the plurality of connection terminals 130 that need to be interconnected. In various other embodiments, it is not necessary to form one insertion slot or the plurality of insertion slots 124 in the module body 121, but rather to arrange the interconnection member 140 within the housing 110 of the electrical connector 100 and outside of the insulation module 120. For example, the interconnection member 140 may be seated (such as clamped) on connection terminals of the plurality of connection terminals 130 in such a manner that the interconnection member 140 abuts against an outer surface of the insulation module 120; this may also interconnect or short-circuit the connection terminals of the plurality of connection terminals 130 within the electrical connector 100 without directly welding the cables.

In some embodiments, an insertion slot of the plurality of insertion slots 124 may extend through a portion of the module body 121 in a second direction (such as a Z direction in the figures) perpendicular to the first direction to open to the corresponding installation hole of the plurality of installation holes 122. The interconnection member 140 may be detachably positioned in insertion slots of the plurality of insertion slots 124, so as to allow for selective installation of the interconnection member 140 or positioning of the interconnection member 140 in the selected insertion slots of the plurality of insertion slots 124 according to actual requirements, enhancing the flexibility of the interconnection.

In embodiments of the present disclosure, there is no specific limitation on the contact form between the interconnection member 140 and the connection terminal(s) of the plurality of connection terminals 130. The interconnection member 140 positioned in the insertion slots of the plurality of insertion slots 124 may be in contact with any conductive portion of the connection terminal(s) of the plurality of connection terminals 130, such as being in surface contact with an outer surface or an outer peripheral surface of the connection terminal(s) of the plurality of connection terminals 130. Illustratively, each connection terminal of the plurality of connection terminals 130 has a terminal body 131 that is elongated, such as a tubular body, in which an elastic clamping member 133 may be installed. The terminal of the mating connector 200 may be inserted and pressed into the elastic clamping member 133 to ensure a reliable electrical connection between the electrical connector 100 and the mating connector 200. In the illustrated embodiments, as shown in FIGS. 10-11, a concave groove 132 may be formed in the outer peripheral surface of the terminal body 131, such as at a substantially middle or waist position of the terminal body 131. Further, a portion of the interconnection member 140 is adapted to be engaged with the concave groove 132; this may have a terminal stopping effect or provide additional terminal retention force to prevent the connection terminal(s) of the plurality of connection terminals 130 from being moved relative to the insulation module 120 in the first direction or being disengaged from the insulation module 120 in the first direction.

For example, as shown in FIGS. 6-7 and 11, the terminal body 131 may further have a flange(s) 135 located on one side or two opposite sides of the concave groove 132. The flange 135 may at least partially define the concave groove 132, and the flange 135 has a larger outer diameter relative to other portions of the terminal body 131. The interconnection member 140 is adapted to abut against the flange 135 when the interconnection member 140 is engaged with the concave groove 132, to establish the stable and reliable electrical contact between the interconnection member 140 and the connection terminal 130.

In some embodiments of the present application, as shown in FIGS. 6-10, the electrical connector 100 may further include an electrically insulated latching member 150, which is also adapted to be partially inserted into a corresponding insertion slot of the plurality of insertion slots 124 and engaged with the concave groove 132 of the corresponding connection terminal of the plurality of connection terminals 130 to prevent the connection terminal 130 from being moved relative to the insulation module 120 in the first direction or being disengaged from the insulation module 120 in the first direction. Therefore, due to the electrically insulated latching member 150 it is not necessary to provide a separate insertion slot of the plurality of the insertion slots 124 for the interconnection member 140, and rather, the electrically insulated latching member 150 or the interconnection member 140 can be selectively or interchangeably installed in the same insertion slot of the plurality of insertion slots 124 as required.

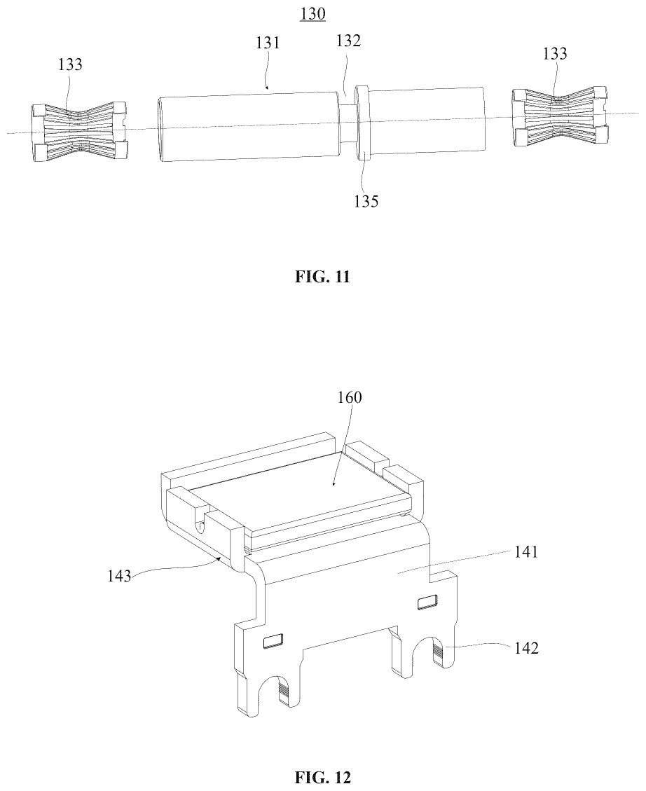

In the embodiments of the present application, there is no specific limitation on the specific form or structure of the interconnection member 140, as long as the interconnection member 140 can electrically connect the desired connection terminals of the plurality of connection terminals 130 within the electrical connector 100. In the embodiments shown in FIGS. 9 and 12-13, the interconnection member 140 comprises a connection body 141 and a clamping portion 142. In the present embodiment, as shown in FIGS. 9 and 12, the clamping portion 142 comprises at least two clamping portions 142. The connection body 141 is adapted to be installed in the respective insertion slot of the plurality of insertion slots 124 of the insulation module 120, and each clamping portion of the at least two clamping portions 142 are adapted to pass through the corresponding insertion slot of the plurality of insertions slots 124 to make contact with the connection terminal of the plurality of connection terminals 130, such as being engaged with the concave groove 132 of the connection terminal of the plurality of connection terminals 130. The embodiment of the interconnection member 140 with the at least two clamping portions 142 is shown in FIGS. 9 and 12, and the embodiment of the interconnection member with three clamping portions 142 is shown in FIG. 13; however, the number of the clamping portions 142 are not limited to those exemplary embodiments, and may include different numbers of the clamping portions 142.

As shown in FIGS. 6-9, when the interconnection member 140 spans two connection terminals of the plurality of connection terminals 130 that are not arranged adjacent to each other or are discontinuously arranged, there is a recess between the at least two clamping portions 142, and an additional latching member 150′ may be arranged in the recess. The additional latching member 150′ being engaged with the concave groove 132 of the connection terminal of the plurality of connection terminals 130 between the two interconnected connection terminals of the plurality of connection terminals 130 to prevent the connection terminal of the plurality of connection terminals 130 from being moved relative to the insulation module 120 in the first direction or being disengaged from the insulation module 120 in the first direction.

In some embodiments, some or all of the clamping portions 142 may extend integrally from the connection body 141. In various other embodiments, at least one clamping portion 142 is separable from the connection body 141 and adapted to make electrical contact with the connection body 141 when the at least one clamping portion 142 is engaged with the corresponding concave groove 135 of each terminal body 131 of the at least two interconnected connection terminals of the plurality of connection terminals 130. For example, as shown in FIG. 13, the clamping portion 142 on the right side is separated from the connection body 141, and the other two clamping portions 142 and the connection body 141 are formed into one piece, which may be used independently to connect two connection terminals of the plurality of connection terminals 130, or may be combined with the separated clamping portion 142 as required to connect three connection terminals of the plurality of connection terminals 130. In other embodiments, the interconnection member 140 may also include a plurality of separated clamping portions or a plurality of sub-interconnection members, two or more of which may be selected to be installed in the corresponding insertion slots of the plurality of insertion slots 124 to form a combined arrangement of electrical contact (e.g., side contact) with each other as required.

Shapes of various clamping portions 142, which are conductive, or sub-interconnection member may be the same, different from each other, or have a structure or contour similar to that of the electrically insulated latching member 150. Thus, the flexibility of the connection terminals of the plurality of connection terminals 130 that are interconnected may be increased. In the illustrated embodiments, the interconnection member 140 has a generally flat profile, and the clamping portion 142 may have a fork-shaped portion with an opening that may have a shape corresponding or matching a profile or shape of the plurality of connection terminals 130 or their respective concave groove 132 to be contacted, such as a substantially arc-shaped or U-shaped shape.

In some embodiments of the present disclosure, the application of the interconnection member 140 may be extended. For example, the respective embodiments of the interconnection member 140 shown in FIGS. 12 and 13, may both further comprise a device holding portion 143, which extends from a side of the connection body 141 (e.g., a side opposite to the clamping portion 142). An additional device, such as a monitoring module 160, may be held or installed (e.g., welded or bonded) on the device holding portion 143. The monitoring module 160 may be used to monitor the electrical, thermal, and connection reliability performance or status of the electrical connector 100. The monitoring module 160 may be fully or partially positioned in the housing 110 of the electrical connector 100. For example, the monitoring module 160 may include a temperature sensor for detecting a temperature of the connection terminal of the plurality of connection terminals 130 that the monitoring module is positioned by; however, the present disclosure is not limited to this.

The electrical connector 100 and the connector assembly, as described above, can make electrical/signal connection between a plurality of electrical devices. For example, the provided electrical connector 100 may be used in a power distribution system to electrically connect electrical equipment to a power supply unit. For example, the provided electrical connector 100 may be used in a cabinet, a power rack of a data center or a server, etc., such as in a cabinet (such as a (OCP) ORv3 rack) that meets industry standards for power source management, where a power source or a power supply unit (PSU) will supply power to various electrical devices or functional units by the electrical connector 100.

1. An electrical connector, comprising:
a housing;
an insulation module at least partially disposed within the housing;
a plurality of connection terminals having different electrical functions and installed in the insulation module at intervals; and
an interconnection member installed on the insulation module, the interconnection member electrically interconnects at least two connection terminals of the plurality of connection terminals.

2. The electrical connector of claim 1, wherein the interconnection member electrically interconnects each connection terminal of the plurality of connection terminals positioned adjacent to each other.

3. The electrical connector of claim 1, wherein one or more connection terminals of the plurality of connection terminals are positioned between the at least two connection terminals.

4. The electrical connector of claim 3, wherein the insulation module includes a module body having a plurality of installation holes penetrating the module body in a first direction, each connection terminal of the plurality of connection terminals is installed in one installation hole of the plurality of installation holes.

5. The electrical connector of claim 4, wherein the module body has a plurality of insertion slots, each insertion slot of the plurality of insertion slots is in communication with one corresponding installation hole of the plurality of installation holes.

6. The electrical connector of claim 5, wherein the interconnection member is partially inserted into at least two corresponding insertion slots of the plurality of insertion slots to make an electrical contact with the at least two connection terminals, the at least two connection terminals are installed in respective installation holes of the plurality of installation holes communicating with the at least two corresponding insertion slots.

7. The electrical connector of claim 6, wherein each insertion slot of the plurality of insertion slots extends through a portion of the module body and opens to a corresponding installation hole of the plurality of installation holes, each insertion slot extends though the portion of the module body in a second direction perpendicular to the first direction.

8. The electrical connector of claim 6, wherein the interconnection member is detachably positioned in the at least two corresponding insertion slots.

9. The electrical connector of claim 6, wherein each connection terminal of the plurality of connection terminals has a terminal body that is elongated with an outer peripheral surface, each terminal body has a concave groove formed in the outer peripheral surface, a portion of the interconnection member is engaged with the concave groove of each terminal body of the at least two connection terminals to prevent movement of the at least two connection terminals relative to the insulation module in the first direction.

10. The electrical connector of claim 9, wherein the terminal body of each connection terminal has a flange that at least partially defines the concave groove of the terminal body, the interconnection member abuts against the flange of each terminal body of the at least two connection terminals when the interconnection member is engaged with the concave groove of each terminal body.

11. The electrical connector of claim 9, further comprising an electrically insulated latching member, the electrically insulated latching member is partially inserted into one insertion slot of the plurality of insertion slots and engages with the concave groove of a corresponding connection terminal of the plurality of connection terminals to prevent the movement of each connection terminal relative to the insulation module in the first direction.

12. The electrical connector of claim 9, wherein the interconnection member has a connection body and at least two clamping portions, the connection body is installed into the at least two corresponding insertion slots, each clamping portion passes through one insertion slot of the at least two corresponding insertion slots and engages with the concave groove of one terminal body of the at least two connection terminals.

13. The electrical connector of claim 12, wherein the at least two clamping portions extend integrally from the connection body.

14. The electrical connector of claim 12, wherein at least one clamping portion of the at least two clamping portions is separable from the connection body to electrically contact the connection body when the at least one clamping portion is engaged with the concave groove of the one terminal body of the at least two connection terminals.

15. The electrical connector of claim 12, wherein the interconnection member has a flat profile, and the at least two clamping portions each have a fork-shaped portion.

16. The electrical connector of claim 12, wherein the interconnection member has a device holding portion extending from a side of the connection body opposite to the at least two clamping portions.

17. The electrical connector of claim 16, further comprising a monitoring module, the monitoring module is held on the device holding portion and monitors an electrical or thermal performance of the electrical connector.

18. The electrical connector of claim 17, wherein the monitoring module has a temperature sensor for sensing a temperature of the connection terminal.

19. A connector assembly comprising:
an electrical connector including:
a housing;
an insulation module at least partially disposed within the housing;
a plurality of connection terminals having different electrical functions and installed in the insulation module at intervals; and
an interconnection member installed on the insulation module, the interconnection member electrically interconnects at least two connection terminals of the plurality of connection terminals; and
a mating connector matable with the electrical connector.

20. The connector assembly of claim 19, wherein the electrical connector is a cable connector and the mating connector is a wire end connector connecting a cable or a board end connector installed on a circuit board.
